(19) United States
(12) Patent Application Publication
(10) Pub. No.: US 2014/0059154 A1
(43) Pub. Date: Feb. 27, 2014

(54) Leader Node Appointment

(71) Applicant: Metaswitch Networks Ltd, Endfield (GB)

(72) Inventor: David HOTHAM, Enfield (GB)

(21) Appl. No.: 13/972,207

(22) Filed: Aug. 21, 2013

(30) Foreign Application Priority Data
Aug. 23, 2012 (GB) 1215074.4

(51) Int. Cl. H04L 12/24

(52) U.S. Cl. CPC H04L 41/04
USPC 709/209

(57) ABSTRACT

Method, apparatus and computer program product for appointing a leader node from a group of nodes in a data communications network. Attribute data comprising status information of one or more nodes in the group is received. At least one attribute associated with the one or more nodes in the group is identified based at least in part on the received attribute data. A given node in the group is appointed, on behalf of the group, to be the leader node when status information has been received for nodes in the group. The appointment is based at least in part on identifying at least one attribute associated with the given node that it is desirable for the leader node to possess. Appointment announcement data announcing that the given node has been appointed as the leader node on behalf of the group is transmitted.

### CROSS REFERENCE TO RELATED APPLICATION

This application claims benefit under 35 U.S.C. §119(a) and 37 CFR 1.55 to UK patent application no. GB 1215074.4, filed on Aug. 23, 2012, the entire content of which is hereby incorporated by reference.

### TECHNICAL FIELD

The present disclosure relates to leader node appointment.

### BACKGROUND

Leadership election in a clustered system of nodes is a well-studied problem. In some known systems, all nodes in the cluster are considered to be equivalent to each other and the problem to be solved is electing a leader node in arbitrary network topologies, often in the face of an unreliable network, or in clusters where nodes may behave in arbitrary ways. It is relatively straightforward to elect a leader node arbitrarily, for example by electing the leader node to be the node having the lowest Internet Protocol (IP) address.

However, known systems for choosing a leader in a more considered manner are typically relatively complicated. For example, US-A1-2009/0165018 describes election of a leader from a group of processes using a leader proposal scheme.

It would be desirable to be able to choose a leader node non-arbitrarily, but in a less complicated manner than in current techniques.

### SUMMARY

In accordance with first embodiments, there is provided a method of appointing a leader node from a group of nodes in a data communications network, the method comprising:

receiving attribute data comprising status information of one or more nodes in the group;

identifying at least one attribute associated with the one or more nodes in the group based at least in part on the received attribute data;

appointing, on behalf of the group, a given node in the group to be the leader node when status information has been received for nodes in the group, said appointing being based at least in part on identifying at least one attribute associated with the given node that it is desirable for the leader node to possess; and

transmitting appointment announcement data announcing that the given node has been appointed as the leader node on behalf of the group.

In accordance with second embodiments, there is provided apparatus for appointing a leader node from a group of nodes in a data communications network, the apparatus being arranged to:

receive attribute data comprising status information of one or more nodes in the group; identify at least one attribute associated with the one or more nodes in the group based at least in part on the received attribute data;

appoint, on behalf of the group, a given node in the group to be the leader node when status information has been received for nodes in the group, said appointing being based at least in part on identifying at least one attribute associated with the given node that it is desirable for the leader node to possess; and

transmit appointment announcement data announcing that the given node has been appointed as the leader node on behalf of the group.

In accordance with third embodiments, there is provided computer program product comprising a non-transitory computer-readable storage medium having computer readable instructions stored thereon, the computer readable instructions being executable by a computerized device to cause the computerized device to perform a method of appointing a leader node from a group of nodes in a data communications network, the method comprising:

receiving attribute data comprising status information of one or more nodes in the group;

identifying at least one attribute associated with the one or more nodes in the group based at least in part on the received attribute data;

appointing, on behalf of the group, a given node in the group to be the leader node when status information has been received for nodes in the group, said appointing being based at least in part on identifying at least one attribute associated with the given node that it is desirable for the leader node to possess; and

transmitting appointment announcement data announcing that the given node has been appointed as the leader node on behalf of the group.

Further features and advantages will become apparent from the following description of embodiments, given by way of example only, which is made with reference to the accompanying drawings.

### BRIEF DESCRIPTION OF THE DRAWINGS

FIG. 1 is a schematic representation of a data communications network in accordance with embodiments;

FIG. 2 is a sequence diagram showing a method of appointing a leader node from a group of nodes in a data communications network in accordance with embodiments;

FIG. 3 is a schematic representation of a data communications network in accordance with embodiments; and

FIG. 4 is a sequence diagram showing a method of appointing a leader node from a group of nodes in a data communications network in accordance with embodiments.

### DETAILED DESCRIPTION

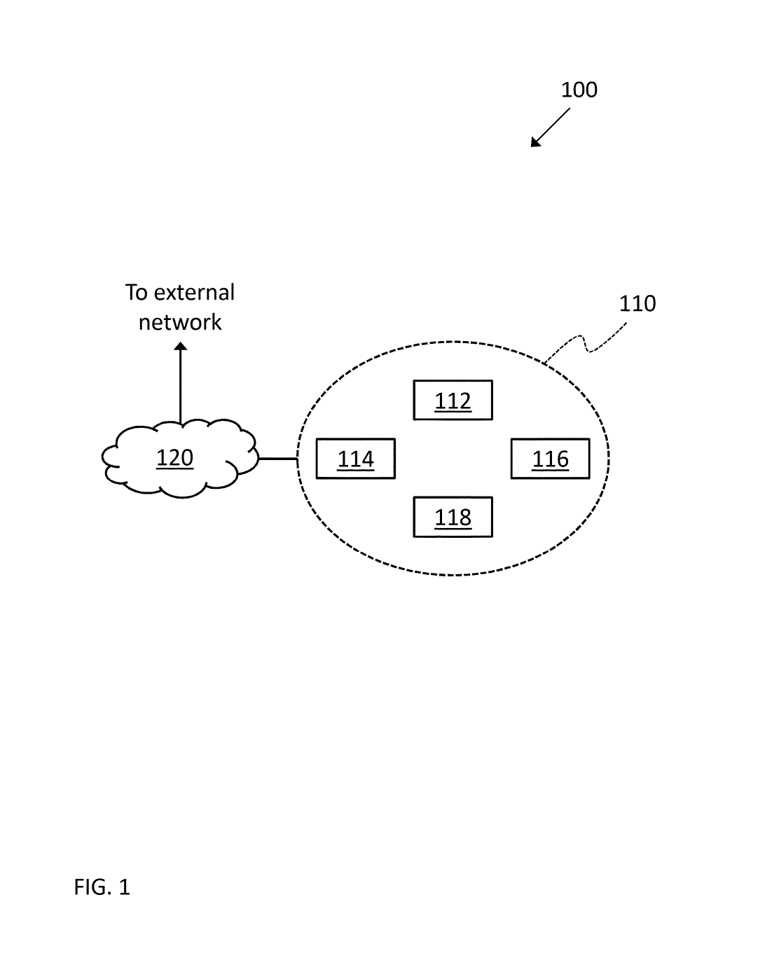

FIG. 1 is a schematic representation of a data communications network 100 in accordance with embodiments. The data communications network 100 includes a group of nodes 110. The group 110 may form a node cluster in that the nodes in the group 110 cooperate such that the cluster appears as though it is a single system outside of the group 110.

In the data communications network 100 depicted in FIG. 1, the group 110 includes four nodes 112, 114, 116, 118. The nodes 112, 114, 116, 118 communicate with one or more external networks via a communications network 120, such as the Internet. In some embodiments, the nodes 112, 114, 116, 118 comprise at least one processor and computer program code stored in at least one memory. The at least one memory and the computer program code are configured to, with the at least one processor, cause the nodes 112, 114, 116, 118 at least to perform a method for use in the upgrade of nodes in a group of nodes in a data communications network as described herein.

In embodiments, the nodes 112, 114, 116, 118 can communicate with each other directly, for example via wired and/or wireless connections. In embodiments, at least some of the nodes 112, 114, 116, 118 communicate with each other via one or more of the other nodes 112, 114, 116, 118 in the group 110. In embodiments, one or more of the nodes 112, 114, 116, 118 is a gateway node via which incoming data for the group 110 is received and/or via which outdoing data from the group 110 is transmitted. The nodes 112, 114, 116, 118 may be, for example, telephony equipment, such as telephony exchanges or switches, call control systems or the like. The nodes 112, 114, 116, 118 may communicate using a message-passing protocol.

Embodiments for appointing a leader node from the group 110 can be implemented in the data communications network 100.

In embodiments, a leader node appointment node is selected from amongst the nodes 112, 114, 116, 118 in the group 110. For example, the leader node appointment node may be selected by one or more of the nodes 112, 114, 116, 118 in the group 110 and/or by one or more entities that is not in the group 110.

The leader node appointment node is used to appoint the leader node on behalf of the group 110. For example, node 114 may be selected as the leader node appointment node. In embodiments, the leader node appointment node 114 is selected arbitrarily from amongst the nodes 112, 114, 116, 118 in the group 110, for example by virtue of it having the lowest IP address. The leader node appointment node 114 could be selected arbitrarily on a different basis, for example by virtue of it having the highest IP address. The leader node appointment node 114 could, instead be selected in a more considered manner, i.e. non-arbitrarily.

The leader node appointment node 114 identifies at least one attribute associated with one or more of the nodes 112, 114, 116, 118 in the group 110. This may involve the leader node appointment node 114 identifying at least one attribute associated with itself.

In embodiments, the leader node appointment node 114 receives attribute data and carries out the identification (of the at least one attribute associated with the one or more of the nodes 112, 114, 116, 118 in the group 110) at least in part on the basis of the at least one attribute being identified from the received attribute data. In embodiments, the received attribute data comprises status reporting data.

The leader node appointment node 114 appoints a given node in the group 110 to be the leader node based at least in part on identifying at least one attribute associated with the given node that it is desirable for the leader node to possess. For example, node 118 may be the given node that is appointed as the leader node for the group 110. In some cases, the leader node appointment node 114 may be able to appoint itself as the leader node, for example if the leader node appointment node 114 identifies that it has at least one attribute that it is desirable for the leader node to possess. The leader node appointment node 114 thus appoints the given node 118 as the leader node on behalf of the group 110.

The leader node is responsible for performing one or more activities in the group 110. For example, the leader node may receive all incoming data for the group 110 and replicate the incoming data to one or more of the other nodes in the group 110. The leader node may be responsible for organizing one or more tasks in the group 110, such as checking whether other nodes in the group 110 have a copy of given data and, if not, providing the given data to nodes that do not have a copy of it.

One or more of the nodes 112, 114, 116, 118 in the group 110 may have their own copy of some state and it may be desirable that the leader node be appointed from among those nodes 112, 114, 116, 118 with the most up-to-date version of that state. In embodiments, the given node 118 is appointed as the leader node based at least in part on the leader node appointment node 114 determining that the identified at least one attribute associated with the given node 118 indicates that the status of given data stored at the given node 118 matches a given status for the given data. In embodiments, the given status for the given data is that it is up-to-date relative to corresponding data stored at one or more other nodes 112, 114, 116 in the group 110. For example, the given data may be configuration data for the group 110 and the given status may be that the configuration data be up-to-date.

The group 110 may contain nodes of different classes, where not all classes are even candidates for leadership. In embodiments, the leadership node appointment node 114 appoints the given node 118 as the leader node based at least in part on the leadership node appointment node 114 determining that the identified at least one attribute associated with the given node 118 indicates that the given node 118 belongs to a given class of node.

It might be desirable that the leader node be geographically close to the center of the group or have some other topological and/or geographical relationship with one or more of the other nodes in the group 110. In embodiments, the leadership node appointment node 114 appoints the given node 118 as the leader node based at least in part on the leadership node appointment node 114 determining that the identified at least one attribute associated with the given node 118 indicates that the given node 118 has a given topological and/or geographical relationship with one or more of the other nodes in the group 110. For example, the leadership node appointment node 114 may receive data from one or more of the nodes 112, 114, 116, 118 in the group 110 comprising topological and/or geographical data and may appoint the given node as the leader node at least in part on the basis of the received data.

The group 110 may contain both passive nodes, that cannot themselves be the leader node but which join the group 110 to monitor its state, and active nodes that can be the leader node. Thus, in embodiments, the group 110 comprises at least one active node and at least one passive node. The leadership node appointment node 114 may appoint the given node 118 as the leader node based at least in part on determining that the identified at least one attribute associated with the given node 118 indicates that the given node 118 is an active node.

Leadership capability may be a dynamic, and not a static, property. For example, some or all of the nodes 112, 114, 116, 118 may be paired off to provide N×1:1 fault-tolerance. In other words, the group 110 may include ‘N’ primary nodes, each of which is paired with a respective backup node. Both primary and backup nodes may be able to join the group 110 but it may be desired that only primary nodes be chosen as the leader node. Primary and backup roles may be reversed dynamically. Thus, in embodiments, the group 110 comprises at least one primary node and at least one backup node. In such embodiments, the leadership node appointment node 114 appoints the given node 118 as the leader node based at least in part on determining that the identified at least one attribute associated with the given node 118 indicates that the given node 118 is a primary node.

In embodiments, the leadership node appointment node 114 appoints the given node 118 as the leader node based at least in part on determining that the identified at least one attribute associated with the given node 118 indicates that the given node 118 is capable of being a leader node.

In embodiments, the leadership node appointment node 114 appoints the given node 118 as the leader node based at least in part on determining that at least one other node 112, 114, 116 in the group 110 has at least one associated attribute that it is undesirable for the leader node to possess. In embodiments, the leadership node appointment node 114 appoints the given node 118 as the leader node based at least in part on determining that at least one other node 112, 114, 116 in the group 110 does not have the at least one associated attribute that it is desirable for the leader node to possess. For example, it may be desirable that the leader node be an active and/or primary node and the at least one other node 112, 114, 116 in the group 110 may not be able to satisfy the leadership node appointment node 114 that it is an active and/or primary node and/or may inform the leadership node appointment node 114 that it is a passive and/or backup node.

The leadership node appointment node 114 transmits appointment announcement data announcing that the given node 118 has been appointed as the leader node. In embodiments, the leadership node appointment node 114 transmits the appointment announcement data to at least one of the nodes 112, 114, 116, 118 in the group 110. In embodiments, the leadership node appointment node 114 transmits the appointment announcement data to all of the nodes 112, 114, 116, 118 in the group 110. In embodiments, the leadership node appointment node 114 transmits the appointment announcement data to at least one entity that is not in the group. The appointment announcement data may be broadcast, unicast, multicast or transmitted in another suitable manner.

In embodiments, a determination is made as to whether a different node 112, 114, 116 in the group 110 should be appointed as the leader node in response to detecting one or more triggers. In embodiments, the one or more detected triggers comprise one or more changes to the membership of the group 110. For example, one of more of the nodes 112, 114, 116, 118 may leave the group 110 and/or one or more additional nodes may join the group 110.

Thus, appointment of a leader node may be broken down into two stages. In the first stage, a leader node appointment node 114 is chosen and is responsible for appointing a leader node on behalf of the group 110. In the first stage, all nodes 112, 114, 116, 118 in the group 110 may be considered to be equivalent and one or more known algorithms and/or known open-source software may be used to select the leader node appointment node 114. Examples of software that may be used to provide this functionality are JGroups and Apache ZooKeeper. In embodiments, the leader node appointment node 114 knows the complete membership of the group 110. If the membership of the group 110 changes, the leader node appointment node 114 may select a new leader node appointment node 114 (possibly itself) and may notify one or more of the nodes in the group 110 of this selection.

In the second stage, the leader node appointment node 114 appoints a leader node on behalf of the group 110. In embodiments, one or more of the nodes 112, 114, 116, 118 in the group 110 report their status to the leader node appointment node 114, and the leader node appointment node 114 appoints the leader node based at least in part on the reported status received from the nodes 112, 114, 116, 118. In embodiments, at least one of the nodes 112, 114, 116, 118 in the group 110 transmits its status information and/or that of other nodes 112, 114, 116, 118 in the group 110 to the leader node appointment node 114. The status information may contain data that is pertinent to appointing the leader node. For example, the status information may comprise timestamp data indicating how up-to-date given data, for example configuration data, stored at the relevant node 112, 114, 116, 118 is, whether the node 112, 114, 116, 118 is capable of leadership or the like. In embodiments, the leader node appointment node 114 waits until it has status information for all of the nodes in the group 110. The leader node appointment node 114 then examines the status information, and appoints a leader node as described above. In embodiments, leader node appointment is restarted if the membership of the group 110 changes during the leader node appointment process.

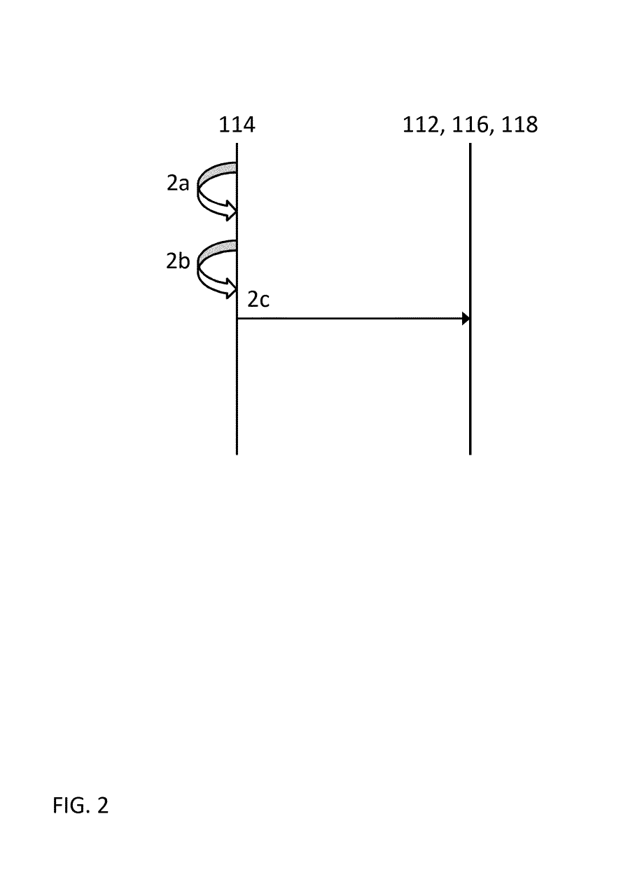

FIG. 2 is a sequence diagram showing a method of appointing a leader node from a group of nodes in a data communications network in accordance with embodiments.

As explained above, in embodiments, the leader node appointment is performed by a leader node appointment node, for example node 114, in the group 110.

At step 2a, the leader node appointment node 114 identifies at least one attribute associated with one or more of the nodes 112, 114, 116, 118 in the group 110.

At step 2b, the leader node appointment node 114 appoints a given node, in this case node 118, in the group 110 to be the leader node based at least in part on identifying at least one attribute associated with the given node 118 that it is desirable for the leader node to possess.

At step 2c, the leader node appointment node 114 transmits appointment announcement data announcing that the given node 118 has been appointed as the leader node. In embodiments, leader node appointment node 114 broadcasts the appointment announcement data to the other nodes 112, 116, 118 in the group 110.

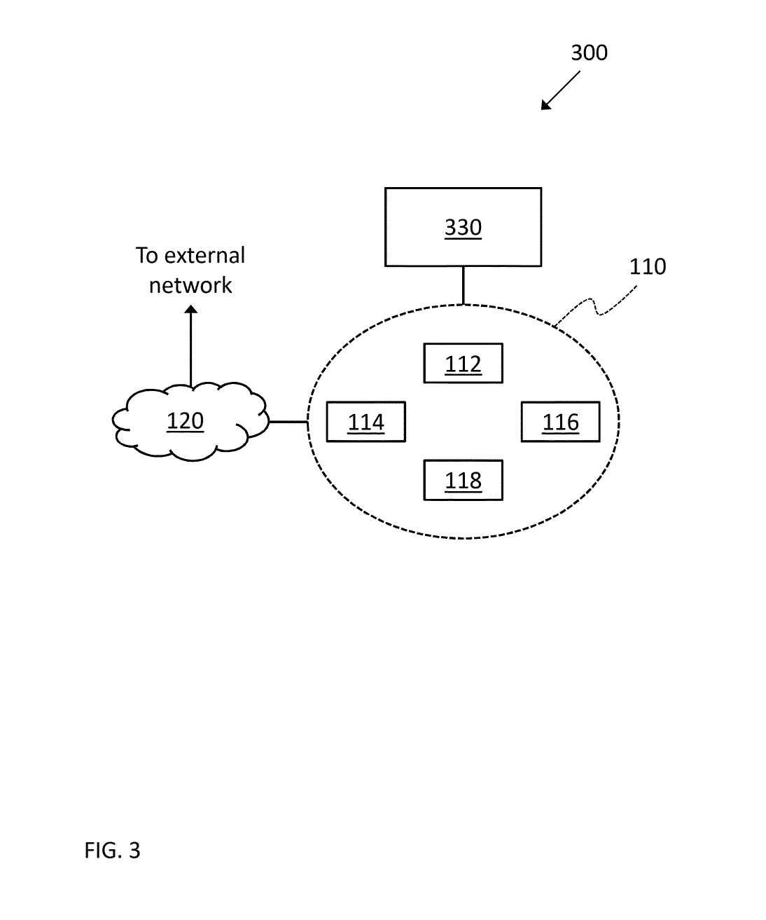

FIG. 3 is a schematic representation of a data communications network 300 in accordance with embodiments.

The data communications network 300 is similar to the data communications network 100 described above in relation to FIG. 1 and like features are identified using the same reference numerals.

In addition, the data communications network 300 includes a leader node appointment entity 330 which is not in the group 110. For example, where the group 110 is managed by a group management system, the group management system could be the leader node appointment entity 330. The leader node appointment entity 330 appoints the leader node on behalf of the group 110.

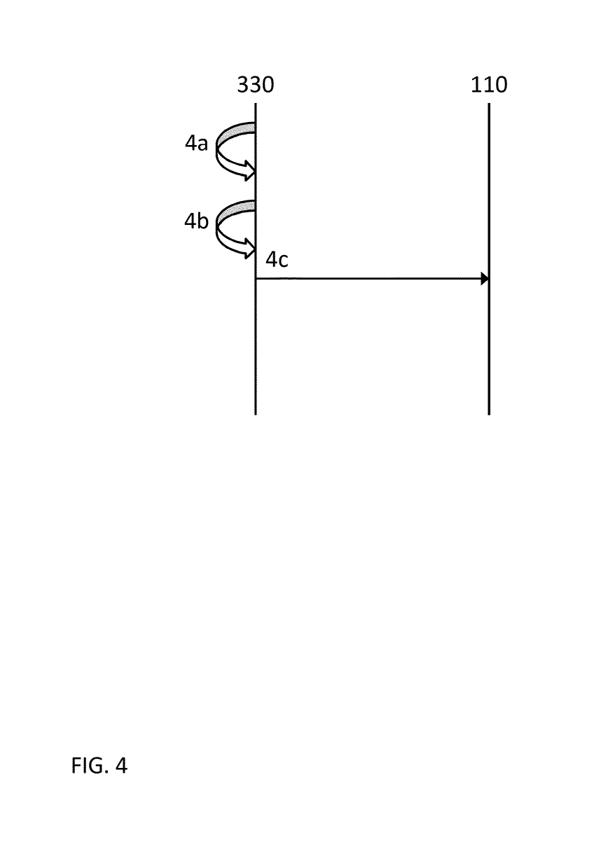

FIG. 4 is a sequence diagram showing a method of appointing a leader node from a group of nodes in a data communications network in accordance with embodiments.

As explained above, in embodiments, leader node appointment is performed by a leader node appointment entity 330 that is not in the group 110.

At step 4a, the leader node appointment entity 330 identifies at least one attribute associated with one or more of the nodes 112, 114, 116, 118 in the group 110.

At step 4b, the leader node appointment entity 330 appoints a given node, in this case node 118, in the group 110 to be the leader node based at least in part on identifying at least one attribute associated with the given node 118 that it is desirable for the leader node to possess.

At step 4c, the leader node appointment entity 330 transmits appointment announcement data announcing that the given node 118 has been appointed as the leader node. The leader node appointment entity 330 may transmit the appointment announcement data to one or more nodes 112, 114, 116, 118 in the group 110.

Various measures (a method, apparatus, computer software, and computer program product comprising a non-transitory computer-readable storage medium having computer readable instructions stored thereon, the computer readable instructions being executable by a computerized device to cause the computerized device to perform a method) of or for appointing a leader node from a group of nodes in a data communications network are provided. At least one attribute associated with one or more of the nodes in the group is identified. A given node in the group is appointed to be the leader node based at least in part on identifying at least one attribute associated with the given node that it is desirable for the leader node to possess. Appointment announcement data announcing that the given node has been appointed as the leader node is transmitted.

In some embodiments, attribute data is received and the identification is carried out at least in part on the basis of identifying the at least one attribute from the received attribute data. In some embodiments, the received attribute data comprises status reporting data.

Various measures (a method, apparatus, computer software, and computer program product comprising a non-transitory computer-readable storage medium having computer readable instructions stored thereon, the computer readable instructions being executable by a computerized device to cause the computerized device to perform a method) of or for appointing a leader node from a group of nodes in a data communications network are also provided. Attribute data comprising status information of one or more nodes in the group is received. At least one attribute associated with the one or more nodes in the group is identified based at least in part on the received attribute data. A given node in the group is appointed, on behalf of the group, to be the leader node when status information has been received for nodes in the group. The appointment is based at least in part on identifying at least one attribute associated with the given node that it is desirable for the leader node to possess. Appointment announcement data announcing that the given node has been appointed as the leader node on behalf of the group is transmitted.

Appointing a leader node in this way is relatively straightforward to implement because the leader node is appointed on behalf of the group of nodes. This is more straightforward to implement than an approach in which nodes communicate with each other to vote for, and then elect, a leader node together.

In some embodiments, the identifying, appointing and transmitting are performed by a leader node appointment node in the group of nodes.

In some embodiments, the leader node appointment node is selected arbitrarily from amongst the nodes in the group of nodes.

In some embodiments, the identifying, appointing and transmitting are performed by a leader node appointment entity that is not in the group.

In some embodiments, the given node is appointed as the leader node based at least in part on determining that the identified at least one attribute associated with the given node indicates that the status of given data stored at the given node matches a given status for the given data.

In some embodiments, the given status for the given data is that it is up-to-date relative to corresponding data stored at one or more other nodes in the group.

In some embodiments, the given node is appointed as the leader node based at least in part on determining that the identified at least one attribute associated with the given node indicates that the given node belongs to a given class of node.

In some embodiments, the group of nodes comprises at least one active node and at least one passive node and the given node is appointed as the leader node based at least in part on determining that the identified at least one attribute associated with the given node indicates that the given node is an active node.

In some embodiments, the group of nodes comprises at least one primary node and at least one backup node, and the given node is appointed as the leader node based at least in part on determining that the identified at least one attribute associated with the given node indicates that the given node is a primary node.

In some embodiments, the given node is appointed as the leader node based at least in part on determining that the identified at least one attribute associated with the given node indicates that the given node is capable of being a leader node.

In some embodiments, the given node is appointed as the leader node based at least in part on determining that at least one other node in the group has at least one associated attribute that it is undesirable for the leader node to possess.

In some embodiments, the given node is appointed as the leader node based at least in part on determining that at least one other node in the group does not have the at least one associated attribute that it is desirable for the leader node to possess.

In some embodiments, the appointment announcement data is transmitted to at least one of the nodes in the group.

In some embodiments, the appointment announcement data is transmitted to at least one entity that is not in the group.

In some embodiments, it is determined whether a different node in the group of nodes should be appointed as the leader node in response to detecting one or more triggers.

In some embodiments, the one or more detected triggers comprise one or more changes to the membership of the group of nodes.

The above embodiments are to be understood as illustrative examples. Further embodiments are envisaged.

For example, although the group 110 described above comprises four nodes 112, 114, 116, 118, the group 110 may comprise a different number of nodes.

In embodiments described above, the identification of at least one attribute associated with one or more of the nodes 112, 114, 116, 118 in the group 110, the appointing of a given node 118 in the group to be the leader node based at least in part on identifying at least one attribute associated with the given node 118 that it is desirable for the leader node to possess, and the transmitting of appointment announcement data announcing that the given node 118 has been appointed as the leader node are all performed by either a leader node appointment node 114 in the group 110 or by a leader node appointment entity 330 that is not in the group 110. However, it will be appreciated that, the identification, appointing and transmitting need not be performed by either a leader node appointment node 114 in the group 110 or by a leader node appointment entity 330 that is not in the group 110. Specifically, the identification, appointing and transmitting may be performed by other apparatus for appointing a leader node from a group of nodes in a data communications network. Furthermore, although, in embodiments described above, various other steps or actions are described as being performed by either a leader node appointment node 114 in the group 110 or by a leader node appointment entity 330 that is not in the group 110, such other steps or actions could be performed at one or more different nodes or entities other than the leader node appointment node 114 or the leader node appointment entity 330. Specifically, such other steps or actions may be performed by other apparatus for appointing a leader node from a group of nodes in a data communications network.

In embodiments, the appointing of the given node as the leader node is based at least in part on determining that the identified at least one attribute associated with the given node indicates that a given upgrade is yet to be applied to the given node. In embodiments, the given upgrade has already been applied to one or more further nodes in the group. The one or more further nodes may be disregarded for the purposes of appointing the leader node; in other words, the one or more further nodes would not be appointed as the leader node. The given upgrade may comprise one or more of a software upgrade, a hardware upgrade, a change of data format and a change of data protocol. In embodiments, data communicated by a node to which the given upgrade is yet to be applied can be understood by a node to which the given upgrade has been applied. In embodiments, data communicated by a node to which the given upgrade has been applied cannot be understood by a node to which the given upgrade has not yet been applied.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of appointing a leader node from a group of nodes in a data communications network, the method comprising:
receiving attribute data comprising status information of one or more nodes in the group;
identifying at least one attribute associated with the one or more nodes in the group based at least in part on the received attribute data;
appointing, on behalf of the group, a given node in the group to be the leader node when status information has been received for nodes in the group, said appointing being based at least in part on identifying at least one attribute associated with the given node that it is desirable for the leader node to possess; and
transmitting appointment announcement data announcing that the given node has been appointed as the leader node on behalf of the group.

2. A method according to claim 1, wherein said identifying, appointing and transmitting are performed by a leader node appointment node in the group of nodes.

3. A method according to claim 2, wherein the leader node appointment node is selected arbitrarily from amongst the nodes in the group of nodes.

4. A method according to claim 1, wherein identifying, appointing and transmitting are performed by a leader node appointment entity that is not in the group.

5. A method according to claim 1, comprising appointing the given node as the leader node based at least in part on determining that the identified at least one attribute associated with the given node indicates that the status of given data stored at the given node matches a given status for the given data.

6. A method according to claim 5, wherein the given status for the given data is that it is up-to-date relative to corresponding data stored at one or more other nodes in the group.

7. A method according to claim 1, comprising appointing the given node as the leader node based at least in part on determining that the identified at least one attribute associated with the given node indicates that the given node belongs to a given class of node.

8. A method according to claim 1, wherein the group of nodes comprises at least one active node and at least one passive node, the method comprising:
appointing the given node as the leader node based at least in part on determining that the identified at least one attribute associated with the given node indicates that the given node is an active node.

9. A method according to claim 1, wherein the group of nodes comprises at least one primary node and at least one backup node, the method comprising:
appointing the given node as the leader node based at least in part on determining that the identified at least one attribute associated with the given node indicates that the given node is a primary node.

10. A method according to claim 1, comprising appointing the given node as the leader node based at least in part on determining that the identified at least one attribute associated with the given node indicates that the given node is capable of being a leader node.

11. A method according to claim 1, comprising appointing the given node as the leader node based at least in part on determining that at least one other node in the group has at least one associated attribute that it is undesirable for the leader node to possess.

12. A method according to claim 1, comprising appointing the given node as the leader node based at least in part on determining that at least one other node in the group does not have the at least one associated attribute that it is desirable for the leader node to possess.

13. A method according to claim 1, comprising transmitting the appointment announcement data to at least one of the nodes in the group.

14. A method according to claim 1, comprising transmitting the appointment announcement data to at least one entity that is not in the group.

15. A method according to claim 1, comprising determining whether a different node in the group of nodes should be appointed as the leader node in response to detecting one or more triggers.

16. A method according to claim 15, wherein the one or more detected triggers comprise one or more changes to the membership of the group of nodes.

17. Apparatus for appointing a leader node from a group of nodes in a data communications network, the apparatus being arranged to:
receive attribute data comprising status information of one or more nodes in the group;
identify at least one attribute associated with the one or more nodes in the group based at least in part on the received attribute data;
appoint, on behalf of the group, a given node in the group to be the leader node when status information has been received for nodes in the group, said appointing being based at least in part on identifying at least one attribute associated with the given node that it is desirable for the leader node to possess; and
transmit appointment announcement data announcing that the given node has been appointed as the leader node on behalf of the group.

18. A computer program product comprising a non-transitory computer-readable storage medium having computer readable instructions stored thereon, the computer readable instructions being executable by a computerized device to cause the computerized device to perform a method of appointing a leader node from a group of nodes in a data communications network, the method comprising:
receiving attribute data comprising status information of one or more nodes in the group;
identifying at least one attribute associated with the one or more nodes in the group based at least in part on the received attribute data;
appointing, on behalf of the group, a given node in the group to be the leader node when status information has been received for nodes in the group, said appointing being based at least in part on identifying at least one attribute associated with the given node that it is desirable for the leader node to possess; and
transmitting appointment announcement data announcing that the given node has been appointed as the leader node on behalf of the group.
